(19) United States
(12) Patent Application Publication
(10) Pub. No.: US 2022/0320573 A1
(43) Pub. Date: Oct. 6, 2022

(54) WATER ACTIVATED BATTERY CELLS WITH PROTECTED LITHIUM ELECTRODE

(71) Applicant: PolyPlus Battery Company, Berkeley, CA (US)

(72) Inventors: Steven J. Visco, Berkeley, CA (US); Yevgeniy S. Nimon, Danville, CA (US); Vitaliy Nimon, San Francisco, CA (US); Bruce D. Katz, Moraga, CA (US)

(73) Assignee: PolyPlus Battery Company, Berkeley, CA (US)

(21) Appl. No.: 17/649,550

(22) Filed: Jan. 31, 2022

Related U.S. Application Data
(60) Provisional application No. 63/263,873, filed on Nov. 10, 2021.
(60) Provisional application No. 63/262,490, filed on Oct. 13, 2021.
(60) Provisional application No. 63/262,387, filed on Oct. 11, 2021.
(60) Provisional application No. 63/260,986, filed on Sep. 8, 2021.
(60) Provisional application No. 63/200,924, filed on Apr. 2, 2021.

(51) Int. Cl. H01M 10/0525; H01M 4/90; H01M 4/36; H01M 4/62; H01M 50/486

(52) U.S. Cl. CPC H01M 10/0525; H01M 4/90; H01M 4/366; H01M 4/621; H01M 50/486; H01M 2004/027

(57) ABSTRACT

A ruggedized high energy density lithium water-activated battery having a compact, readily manufacturable, and scalable electrode stack structure has enhanced tolerance to stress conditions such as shock and vibration, which may be experienced during shipping, transport and/or deployment into a waterbody (e.g., an ocean).

### FIELD OF THE DISCLOSURE

This disclosure generally relates to batteries, and in particular embodiments to a water-activated battery, such as a reserve battery, employing a protected lithium electrode as the negative electrode. For example, such a battery may be activated upon immersion into a waterbody or becoming filled with water, typically seawater.

### BACKGROUND

Prior work has developed technology for high energy density lithium water-activated reserve batteries that function when immersed in the ocean by making use of seawater as an electrolyte. For powering marine devices, these batteries have demonstrated unprecedented energy density. However, the technology would be further advanced by the development of appropriate ruggedization techniques that would facilitate and/or optimize the incorporation or such batteries and electrode components into marine devices that may experience moderate to severe shock and vibration during shipping, transport, or deployment into the ocean.

### SUMMARY

In one aspect the present disclosure provides a ruggedized high energy density lithium water-activated battery, such as a reserve battery, having a compact, readily manufacturable, and scalable electrode stack structure with enhanced tolerance to stress conditions such as shock and vibration, which may be experienced during shipping, transport and/or deployment into a waterbody (e.g., an ocean). Lithium water-activated batteries of the present disclosure have an architecture that is open to the ocean environment, and seawater therefrom is used to support the electrolyte functionality of the battery. As described in detail below, the ruggedization techniques provided herein take advantage of the open architecture of the batteries and their operation in a waterbody environment.

For certain marine applications, ruggedization is paramount. For instance, air dropping the battery into the ocean can lead to a shock wave that subjects the electrodes to a high amount of axial force. However, battery ruggedization is a challenge because, for example, the available space inside a marine device may be severely limited, and the weight of the battery restricted. Accordingly, battery ruggedization without overburdening its size or overcomplicating its design or integration into the marine device (e.g., a sonobuoy or ocean bottom sensor/node) would be desirable. Moreover, ruggedization be achieved with simplicity in a cost-effective manner, and thus without hindering manufacturability or scalability of battery size, would be further desirable.

It is a particular aspect of the present disclosure to provide methods and techniques for ruggedizing the instant battery while maintaining a geometrically simple and compact electrode stack structure. In various embodiments, the method involves optimizing the tradeoff between strength of the ruggedization and the burden that ruggedization has on the volume and geometric form of the electrode stack. Accordingly, in various embodiments the high energy density lithium water-activated battery of the present disclosure has a compact and simple geometric form that is sufficiently ruggedized without overburdening its volume. By sufficiently rugged it is meant that the battery or electrode stack structure is mechanically strong enough to withstand the shock and vibration associated with the transport and deployment of the battery, without damaging the electrodes. From a manufacturing perspective, some of the methods described herein also allow for tailoring the degree of ruggedization to the anticipated environmental stresses without having to make major changes to the simple geometric form of the electrode stack structure, which is key to achieving the necessary strength with minimal energy density reduction and cost penalty. For example, in various embodiments the lithium water-activated battery of the present disclosure has a simple compact electrode stacking structure that is sufficiently ruggedized to be used as the power source in an aerially deployed sonobuoy or an ocean bottom node that is dropped off the side of a ship.

In accordance with the ruggedization and volume minimization aspect of the present disclosure, the instant battery and electrode stack is fortified by a volume minimized shock absorbing member that is configured in the electrode stack to absorb axial forces and dissipate energy of a shock force associated with a waterbody impact. In some embodiments the shock absorbing member is composed of shock mitigating materials. In other embodiments, the shock absorbing member is constructed of materials that are not generally considered shock mitigating to one of skill in the mechanical arts but is nonetheless sufficiently protective against axial impact forces based on its construction, configuration, and positioning within the electrode stack. In yet other embodiments the shock absorbing member is a composite composed of shock mitigating materials and other materials not generally considered to be shock mitigating.

Importantly, in various embodiments the shock absorbing member should not interfere or unduly reduce the electrochemical performance of the battery. In various embodiments the shock absorbing member is a transient component that is designed to drift or dissolve away from the battery after it has been deployed in the ocean, and the shock associated with the waterbody impact has been absorbed.

In various embodiments the shock absorbing member is constructed in the form of a solid phase spacer that is sandwiched between opposing anode and cathode electrodes. In accordance with the present disclosure, the design, configuration, and material construction of the spacer involves a tradeoff between size and shock absorbing capacity. If the spacer member is too large it may lead to an unacceptable penalty in terms of volumetric energy density. In various embodiments the spacer is in the form of a multi-layer having volume and shock absorbing capacity that is optimized by properly selecting the thickness and shock mitigating material of each layer and configuring the layers to ensure that it (the shock absorbing spacer member) is: i) chemically compatible in contact with the adjacent electrodes; ii) capable of providing the necessary resistance to shock and vibration associated with the anticipated waterbody impact; iii) volumetrically minimized to ensure that the high energy density of the battery is maintained; and iv) not interfering with the operation and performance of the battery. Preferably, the thickness of the spacer member is less than the thickness of the anode, and even more preferably less than that of either the anode or the cathode.

In its simplest form the battery is an electrode stacking composed of an alternating arrangement of anodes and cathodes. In various embodiments each electrode may have a peripheral frame member that may be used for a number of purposes, including, for example, as a supporting structure to improve ease of manufacture and/or facilitate proper alignment and spacing between electrodes after the marine device has been deployed in/on the waterbody. In various embodiments the shock absorbing member is constructed in the form of a spacer component disposed between opposing anode and cathode electrodes.

During storage and transport to the deployment site, the battery (or electrode stack) is typically in a substantially dry inactive state (i.e., it is dry prior to being deployed). Then, substantially immediately upon deployment or immersion of the marine device into the waterbody, or some period of time thereafter, the battery is activated as waterbody liquid, infusing between the anodes and cathodes sets up an ionic pathway that essentially closes the electrical circuit. Preferably, the activating waterbody liquid is sufficiently saline and ionically conductive to serve as an unsupported liquid electrolyte throughout the entirety of battery operation, including initial startup. However, in some embodiments, the shock absorbing member may include a water-soluble ionic compound that benefits the startup behavior as it dissolves into the waterbody to support its electrolyte functionality. For instance, the dissolution may be exothermic and thereby heat the seawater nearby the electrodes and thus provide a temporary boost in the ionic conductivity.

In accordance with various embodiments of the present disclosure the ruggedized lithium water-activated battery includes one or more lithium anodes, which, in whole or in part, is composed of a water-stable protected lithium electrode (PLE). Details pertaining to embodiments of the structure, chemical makeup, and methods of making water-stable protected lithium electrodes (ws-PLE) for use herein as an electrode component in a ruggedized lithium water-activated battery of the present disclosure are described in U.S. Pat. Nos. 7,824,806, 8,404,388 and 9,905,860, which are incorporated by reference herein in their entirety for such disclosure. Briefly, such water-stable protected lithium electrodes are composed of a lithium electroactive layer (typically a lithium metal layer, such as a Li foil or sinter thereof) that is protected on its major surfaces by a pair of opposing water-stable Li ion conducting ceramic membranes which are substantially impervious to the waterbody liquid and preferably pinhole free. The ws-PLE is also sealed about its edges. In various embodiments the seal is compliant to thickness changes associated with battery discharge, as Li ions migrate through the ceramic membrane into the adjacent waterbody liquid.

In various embodiments, the battery/electrode stack is configured such that the shock absorbing spacer(s) are in mechanical continuity with adjacently opposing electrodes. In particular embodiments the spacer is in direct touching contact with the opposing electrodes. In accordance with a ruggedized battery of the present disclosure, in various embodiments, the spacer component is composed of one or more solid or gel phase material layer(s) that cover, in direct touching contact, the entire electrochemically active surface of one or both electrodes (e.g., completely covers the electroactive surface of the anode). In various embodiments the spacer component is electrically insulating prior to deployment in the waterbody and thus its coverage over the active surface of the anode renders the stack electrochemically inoperable until it (the spacer) is removed, post impact. Accordingly, in various embodiments the spacer member is impermanent/transient or fugitive in that it is designed to migrate/float/sink/drift away from the inter-electrode gap and/or dissolve into the seawater (or more generally the waterbody liquid) after the ruggedized battery has been deployed/immersed into the waterbody. In some embodiments the dissolution of the spacer member benefits the startup behavior of the battery. For instance, in various embodiments the spacer member is composed, in whole or in part, of a salt (ionic compound) that upon dissolution enhances the ionic conductivity of the seawater between electrodes.

In various embodiments the ruggedized water-activated battery is based on an alkali metal anode, and, in particular, a lithium metal anode. For instance, the battery and stack may be a lithium seawater battery composed of water-stable protected lithium electrodes, as described in U.S. patents and in the literature here.

In various embodiments the spacer member is positioned in direct and intimate touching contact between adjacently opposing electrodes. In various embodiments, the anode is a water-stable protected lithium electrode (as described above) having first and second opposing inorganic ceramic membranes that define the major electrochemically active surfaces of the anode, and the spacer member is positioned to directly cover, in intimate touching contact, the entire active surface of the inorganic ceramic membrane. In various embodiments the PLE has what is termed herein a “recessed gap” or “basin region” caused by the thickness of the peripheral edge seal in direct touching contact with the cathode electrode, and in particular the electroactive surface of the cathode. In some embodiments the spacer component is configured to only cover, in direct touching contact, the ceramic membrane, and the thickness of the spacer may be equal to or greater than the gap between the ceramic surface and the cathode surface. For instance, in various embodiments the recessed gap is not greater than 1 mm and the spacer component thickness is 1 mm or greater (e.g., about 1 mm or about 2 mm). In other embodiments the recessed gap is not greater than 0.5 mm and the spacer component thickness is 0.5 mm or greater (e.g., about 0.5 mm or about 0.6 mm or about 0.7 mm, or about 0.8 mm, or about 0.9 mm, or about 1 mm).

In various embodiments the spacer member is elastomeric. In particular embodiments the elastomeric spacer is substantially dense (e.g., having incidental void volume <10% or <5%). In various embodiments the elastomeric spacer is a transient component that dissolves substantially immediately upon activation (e.g., once immersed in the waterbody), or a short time after immersion (e.g., within seconds or minutes). In other embodiments the transient spacer member(s) may simply float away from the electrochemical boundary region of the battery after immersion into the waterbody (i.e., the region between opposing electrodes). The transient spacer is not necessarily intended to provide or enhance electrochemical functionality. In fact, were the shock absorbing spacer to remain between electrodes after activation, and during battery operation, its presence could degrade battery performance or otherwise entirely prevent the battery from working. In various embodiments the elastomeric spacer is a homogenous single-phase material. In particular embodiments the elastomeric spacer is a polymer such as polyethylene oxide, that readily dissolves in the presence of excess of water.

In various embodiments the battery is composed of a protected lithium electrode (PLE) as the electrochemically active component of the anode. In various embodiments the electrochemically active component of the cathode is an electron transfer medium (e.g., porous) that provides a surface for the electro-reduction of oxygen and/or water in support of battery discharging. In various embodiments the anode and cathodes include a peripheral frame member, typically a rigid ring/annular shaped frame, interfacing with the PLE or electron transfer medium about its circumference, and therewith providing mechanical support for the electrochemically active component as well as surfaces, electrical ports and guide holes for efficient wiring and positional alignment of opposing electrodes.

In various embodiments the shock absorbing member may be made of an elastic material such as rubber or urethane. In some embodiments, the shock absorbing member substantially covers (directly or indirectly) in mechanical continuity the entire active surface of the ceramic membrane. The shock absorbing member may be configured to receive an impact load applied axially and capable of being axially compressed by the impact load. The present disclosure provides a shock absorbing member that is configured to be capable of receiving an impact load generated when the battery/stack impacts the waterbody, effectively absorbing the impact load. The ruggedized battery and electrode stack may be capable of withstanding large impact forces of kinetic energy. The shock absorbing member converts the kinetic energy of the impact into an energy form that is not harmful to the battery and in particular the PLE, and even more particularly the ceramic membrane of the PLE. Without intending to be limited by theory, the shock absorbing member may absorb the shock of waterbody impact through deformation. The shock absorbing member may effectively absorbs the shock forces while having a small volume. In various embodiments the anode and/or cathode are further ruggedized by a peripheral support member slotted to receive the electrodes and circumferentially interfaces with the electrodes to provide both structural support and as an exterior substrate that may be used to support wiring, electronic components, and guide holes for suspension cords, as described herein below.

In another aspect the present disclosure provides cathodes for use in a seawater activated battery. In one embodiment, when the cathode reaction is an electrochemical reduction of water molecules (electrochemical hydrogen evolution) or electroreduction of oxygen dissolved in water (in particular, in seawater), the cathode employs a porous material (usually having through porosity), such as a metal mesh, gauze, screen, or ExMet, or a carbonaceous material, such as carbon mesh, gauze, screen, having a catalyzed surface. In this case, the surface of metal or carbon facilitates electrochemical reactions of oxygen reduction or hydrogen evolution, or both of these reactions. In a specific embodiment, the cathode employs a titanium ExMet coated with catalytic particles. In one such case, the catalyst is MoS₂, in particular nanoparticles of MoS₂, which is known to catalyze electrochemical hydrogen evolution. In a specific embodiment, the catalyst is platinum or other metals from the platinum group, for example a titanium ExMet may be coated with platinum having a surface density in the range from 0.01 mg/cm² to 1.0 mg/cm². Platinum group metals are efficient catalysts of both hydrogen evolution and oxygen reduction cathode reactions that can take place in seawater.

In yet another aspect the present disclosure provides a ruggedized extensible water activated reserve battery assembly composed of a plurality of ruggedized battery and an extendable suspending mechanism that allows for the inter-electrode gap to expand to a pre-determined distance, while maintaining center alignment of the electrodes. In various embodiments the extendable/extensible seawater activated reserve battery system (sometimes referred to as telescoping) has an inter-electrode gap between opposing cathode and anode electrodes that extends after or upon deployment of the battery system in a waterbody (“extended state”). In accordance with this aspect of the disclosure, in various embodiments the battery is stored and/or transported to the deployment site having a compact electrode stacking (“compact state”) and then, upon or after deployment in the waterbody, the electrode stack extends, causing the inter-electrode gap to increase. In various embodiments, the extendable battery system has a blind-type construction wherein the electrodes are coupled to a flexible support mechanism that controls the magnitude of the extension and therewith the length of the inter-electrode gap (or more simply the gap). For instance, the battery/stack having a small or zero gap during storage/transport to the deployment site and expanding to a larger pre-determined gap once the battery assembly has been deployed or immersed into the waterbody (e.g., just prior to, or simultaneous with, battery operation). In various embodiments, the suspending mechanism serves to maintain the battery and its electrode stack in a vertical position throughout the useful service of the battery. In various embodiments the suspending mechanism is gravity and buoyancy driven. For example, once the battery assembly is deployed into the waterbody, the battery electrode stack is caused to experience a downward sinking force and an upward buoyancy force, that in combination causes the inter-electrode gap to increase to the pre-determined operating distance, which, in turn, extends the height of the electrode stack from its compact state to its extended state. The sinking/downward force may be brought about by the weight of the battery (e.g., the electrodes) and/or that of the underwater device being powered, and/or that of an anchor member coupled to the electrode stack, on or above the seafloor, and the buoyancy/upward force may be brought about by a buoyancy element coupled to the battery electrode stack. For instance, in various embodiments the battery assembly includes distally positioned top and bottom cover plate members, the top cover plate coupled to the buoyancy element (e.g., a float) and the bottom cover plate coupled to an anchor member.

### BRIEF DESCRIPTION OF THE DRAWINGS

FIGS. 1A-B illustrates, in cross section, a ruggedized water activated battery and battery electrode stack in accordance with an embodiment of the present disclosure.

FIGS. 2A-B illustrate, in top-down views, a ruggedized anode and ruggedized cathode in accordance with embodiments of the present disclosure.

FIG. 3 illustrates, in cross section, a ruggedized water activated battery in accordance with an embodiment of the present disclosure.

FIG. 4 illustrates, in cross section, a ruggedized water activated battery in accordance with an embodiment of the present disclosure.

FIG. 5 illustrates, in cross section, a ruggedized water activated battery after it has been deployed in a waterbody, in accordance with an embodiment of the present disclosure,

FIG. 6 illustrates a ruggedized water activated battery electrode stack assembly in accordance with an embodiment of the present disclosure.

FIGS. 7A-B illustrates a ruggedized water activated battery electrode stack assembly, in cross sectional view, before and after immersion in a waterbody, in accordance with an embodiment of the present disclosure.

FIG. 8A-B illustrates a ruggedized water activated battery electrode stack assembly, in perspective view, before and after immersion in a waterbody, in accordance with an embodiment of the present disclosure.

FIGS. 9A-B illustrates a ruggedized water activated battery electrode stack assembly, in cross sectional view, after immersion in a water body, in accordance with embodiments of the present disclosure.

### DETAILED DESCRIPTION

Reference will now be made in detail to specific embodiments of the disclosure. Examples of the specific embodiments are illustrated in the accompanying drawings. While the disclosure will be described in conjunction with these specific embodiments, it will be understood that it is not intended to limit the disclosure to such specific embodiments. On the contrary, it is intended to cover alternatives, modifications, and equivalents as may be included within the spirit and scope of the disclosure as defined by the appended claims. In the following description, numerous specific details are set forth in order to provide a thorough understanding of the present disclosure. Embodiments of the present disclosure may be practiced without some or all of these specific details. In other instances, well known process operations have not been described in detail in order not to unnecessarily obscure the present disclosure.

When used in combination with “comprising,” “a method comprising,” “a device comprising” or similar language in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

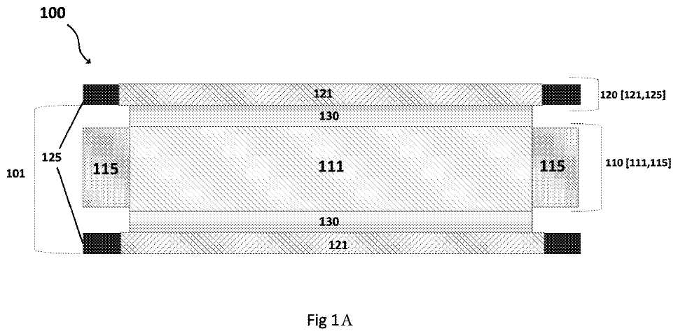

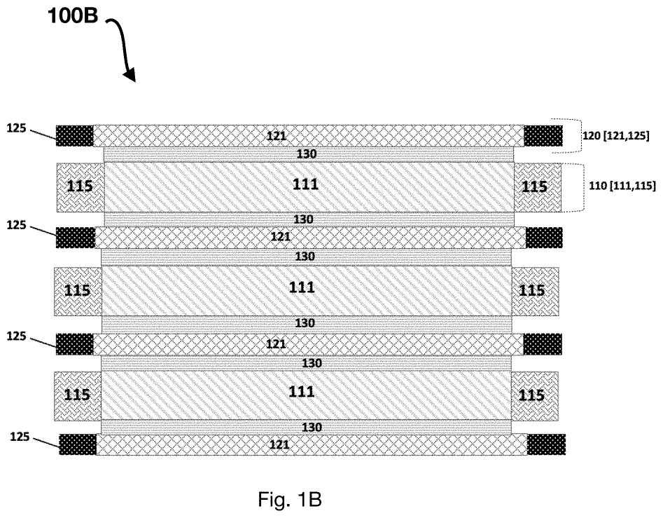

In accordance with various embodiments of the present disclosure ruggedized water activated battery 100 and battery electrode stack 100B are cross sectionally depicted in FIGS. 1A-B prior to being immersed and operated in a waterbody, such as an ocean. Battery 100 includes anode electrode 110, opposing cathode electrode 120, and shock absorbing member 130, which is configured and materially constructed to ruggedize battery 100 against impact damage that might otherwise arise during shipping, transport, or deployment in a waterbody.

As illustrated in FIG. 1B, battery 100 is configured as one of a plurality of electrodes making up a multi-electrode stack 100B that is intended to power a marine device or apparatus, such as a sonobuoy, ocean bottom sensor-node, or unmanned underwater vehicle. In various embodiments, electrode stack 100B is an alternating stacking of anodes 110 and cathodes 120. As illustrated in FIG. 1B, electrode stack 100B has 3 anodes and 4 cathodes. However, the present disclosure contemplates any number of two or more anodes and the corresponding requisite number of cathodes. Increasing the number of stacked electrodes generally increases the energy of the battery and its power capability. In various embodiments, the electrode stack has one additional cathode beyond the number of anodes, such that the top and bottom of the stack are both cathodes. The electrode stack may have any number of electrodes. In various embodiments the electrode stack has “n” anodes and the requisite amount of (n+1) cathodes. For instance, 10 anodes and 11 cathodes, or 20 anodes and 21 cathodes, or 30 anodes and 31 cathodes. When ruggedized, the inter-electrode gap between each opposing cathode and anode includes a shock absorbing member 130. Generally, the number of shock absorbing members in the electrode stack is 2n. In various embodiments the anodes are electrically connected to each other and likewise the cathodes.

Preferably, battery 100 is sufficiently rugged to withstand the impact of an aerial deployment (e.g., the dropping of a sonobuoy from an airplane) or an airdrop of significant height (e.g., an ocean bottom sensor-node deployed off the side of a ship). Without intending to be limited theory, shock absorbing member 130 effectively converts kinetic energy of the waterbody impact into an energy form that is not harmful to the battery or any of its components. In accordance with various embodiments, shock absorbing member 130 is positioned to effectuate mechanical continuity between electrodes along their normal direction, and therewith reduce, and preferably minimize, axial forces stemming from the waterbody impact. For instance, the shock absorbing member disposed in direct touching contact with the opposing major surfaces of the anode and cathodes, as illustrated in FIG. 1.

Battery 100 is further ruggedized and functionalized by framing support members 115/125 which provide strength and rigidity to the electrodes and may serve as a substrate or surface on which battery management electronic components may be positioned and guide holes and suspension mechanisms (e.g., vertical suspension cords) may be configured for aligning and controlling the spacing between the electrodes, especially for an extensible battery/electrode stack as described in more detail herein below.

Continuing with reference to FIG. 1, each electrode has an electrochemically active component or region 111/121. In the illustrated embodiment anode 111 is double-sided, having first and second opposing surfaces that are electrochemically active and configured for releasing active metal ions into the waterbody during battery discharge, when the anode undergoes electrochemical oxidation. Battery 100 is shown having two cathodes on either side of double-sided anode 110. When the electrodes are incorporated as one of a plurality of electrodes in a multi-electrode stack, the cathodes are also generally double-sided.

In various embodiments the ruggedized battery and electrode stack of the present disclosure is a lithium seawater battery having a water-stable protected lithium electrode as the anode and an opposing cathode. In various embodiments, chemical constituents of the waterbody serve as the cathode active species (e.g., water molecules and/or dissolved oxygen molecules), which are electrochemically reduced at surfaces of an electron transfer medium that serve as the cathode electrode (sometimes referred to herein as a type I cathode). However, the invention is not limited to this type of cathode construction. For instance, cathode electrode 121 may be constructed, in whole or in part, of solid phase electroactive material (a type II cathode), including sintered or pressed electroactive sheets or discs (e.g., pressed sheets of an electroactive metal halide compound, such as silver chloride or copper chloride). Details regarding the use of both type I and type II cathodes in lithium seawater batteries are described in U.S. Pat. Nos. 7,824,806, 8,404,388 and 9,905,860, which are incorporated by reference herein in their entirety for such disclosure. In various embodiments it is contemplated that the cathode may be a combination of both type I and type II.

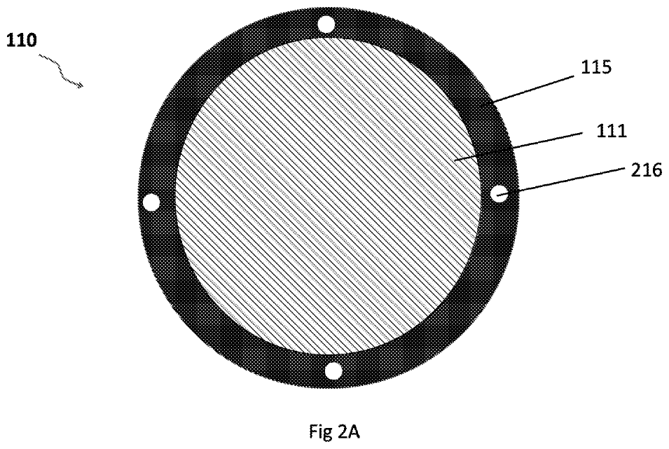

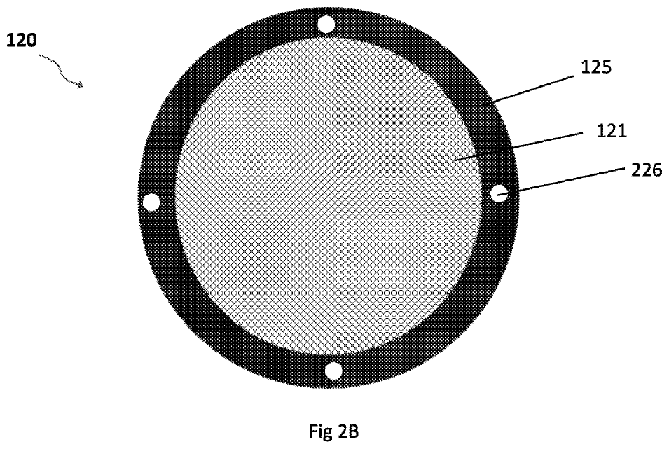

In accordance with various embodiments of the present disclosure, anode and/or cathode may be further ruggedized and functionalized by interfacing a support member 115/125 to the peripheral edges about the circumference of the electrode. The support members are more clearly illustrated in FIGS. 2A-B, showing top-down views of anode electrode 110 (in FIG. 2A) and cathode electrode 120 (in FIG. 2B). The support member generally has a frame-like configuration about the electrode (e.g., annular or ring-like shaped). Support members 115/125 are not electrochemically active components of the electrode, but rather enhance strength, ease handling, and facilitate assembly and alignment of the electrodes when constructed as an electrode stack. For instance, support members 115/125 may serve as a substrate for affixing battery management electronics and/or as a rigid substrate frame with positional guide holes/slots 116/126 to facilitate aligning the electrodes during assembly and operation. Adjacent electrodes may be interlocked to each other via the peripheral support members to enhance mechanical strength on transport. As described in more detail herein below, the support members may be used to interface with a suspending mechanism to facilitate operable changes to the spatial arrangement of the electrodes and/or inter-electrode distances (i.e., inter-electrode gap) upon deployment (e.g., after being immersed/activated upon deployment into the waterbody).

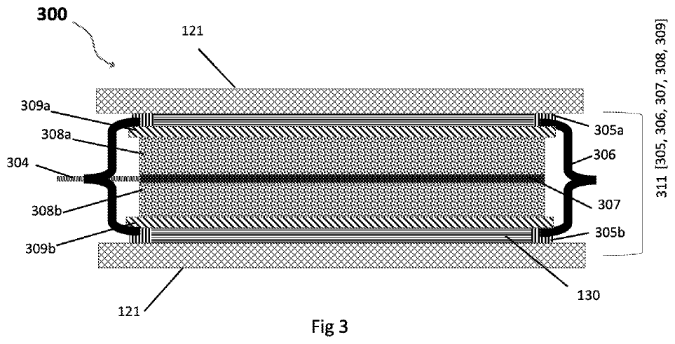

In various embodiments, anode 110 is based on a water-stable protected lithium electrode (PLE) serving as electrode 111. A battery having a ws-PLE in accordance with various embodiments of the present disclosure is illustrated in cross section in FIG. 3. For sake of clarity, battery 300 is illustrated in the absence of support members about the electrodes. Battery 300 includes PLE 311 serving as negative electrode (i.e., anode), positive electrode (i.e., cathode) 121 and shock absorbing member 130. PLE 311 has a sandwich structure composed of substantially impervious Li ion conducting ceramic membranes 309a/b, lithium metal foils or sinters 308a/b and current collector 307 sandwiched between the lithium foils. In various embodiments the PLE includes an interlayer between the ceramic membrane and the opposing lithium metal foil. For instance, the interlayer may be thin solid-state Li ion conducting layer (e.g., a LiPON layer or the like) or it may be a liquid or gel electrolyte interlayer, such as a porous separator layer impregnated with a non-aqueous Li ion conducting liquid electrolyte having stability to Li metal. Protected lithium electrodes having solid and liquid/gel phase interlayers are described in U.S. Pat. Nos. 7,282,296, 7,858,223, 9,362,538, 9,601,779, 7,282,295 and 10,916,753, which are incorporated by reference herein for this disclosure.

Continuing with reference to FIG. 3, PLE 311 has a peripheral seal structure 306 (e.g., a multi-layer laminate), and secondary seals 305a/b covering exposed edges of seal 306. In various embodiments the peripheral seal structure 306 is a compliant seal (e.g., a multi-layer laminate), and ws-PLE 311 is compliant to changes of lithium thickness during battery discharge. Compliant seal structures and PLEs having compliant seal structures, and batteries having PLEs with compliant seal structures are fully described in U.S. Pat. No. 7,824,806, incorporated by reference herein this disclosure.

The capacity of the PLE is determined by the amount of lithium, and, in particular, thickness of lithium sinter 308a/b. Typically layer 308a and 308b have the same thickness. Generally, thicker lithium metal foils or foil sinters support higher specific capacity anodes (i.e., higher Ah/kg). In various embodiments thickness of lithium metal layer 308a/b is 1 to 5 mm, however the disclosure is not limited as such and thicker foils/sinters are contemplated (e.g., between 5 to 10 mm).

Cathode 121 may be an electron transfer medium (e.g., porous, or dense electronically conductive sheet or plate) and, in some embodiments, may further comprise solid phase electroactive material. In various embodiments the cathode is a porous carbonaceous network having a porous framework structure (e.g., carbon paper or carbon cloth or metal mesh or metal/carbonaceous foam or the like), and additionally incorporating high surface carbon particles adhered to the framework. In some embodiments the cathode may be a titanium mesh or expanded metal network. In the case when the cathode reaction is an electrochemical reduction of water molecules (electrochemical hydrogen evolution) or electroreduction of oxygen dissolved in water (in particular, in seawater), the cathode employs a porous material (usually having through porosity), such as a metal mesh, gauze, screen, or expanded metal (sometimes referred to herein as “ExMet”), or a carbonaceous material, such as carbon mesh, gauze, screen, having a catalyzed surface. In this case, the metal or carbon surfaces facilitate electrochemical reactions of oxygen reduction or hydrogen evolution, or both of these reactions. In embodiments, the cathode is a titanium ExMet coated with catalytic particles. In embodiments, the catalyst is MoS₂, in particular nanoparticles of MoS₂, which is known to catalyze electrochemical hydrogen evolution. In embodiments, the catalyst is platinum or other metals from the platinum group. In particular embodiments, a titanium ExMet is coated with platinum having a surface density in the range from 0.01 mg/cm² to 1.0 mg/cm². Platinum group metals are efficient catalysts of both hydrogen evolution and oxygen reduction reactions that can take place at/on cathode 121 when immersed in seawater.

In other embodiments cathode 121 may be a type II cathode based on solid phase electroactive material, such as silver chloride particles, cuprous chloride, and/or other Cu (1) compounds, and the like. The solid phase electroactive particles may be formed into a cathode sheet or disc by pressing and/or sintering techniques. The sintered cathodes may be dense or porous depending on the intended power demand of the application. Porous cathodes having more surface area exposed to the seawater will generally have higher discharge rate capability.

In accordance with the present disclosure, battery 300 is ruggedized by the incorporation of shock absorbing member 130 which is positioned between anode electrode 311 and cathode electrode 121. Therebetween, member 130 serves as a solid material spacer that effectively absorbs and protects ceramic membrane 309 from mechanical damage upon impact with the waterbody during battery deployment. In various embodiments, member 130 is sandwiched between the opposing electrodes in direct touching contact, and therefore member 130 needs to be chemically compatible with the ceramic membrane 309 as well as chemically compatible with material of the cathode which it contacts. Once battery 300 is deployed in a waterbody, member 130 will drift away from the electrochemical boundary region between the electrodes (i.e., away from the electrical field lines defined by the electrode stack geometry). In various embodiments shock absorbing member 130 is designed to rapidly dissolve in seawater, leaving behind an interelectrode gap that quickly fills with seawater. Suitable shock absorbing members may be one or more layers of an inorganic, organic, polymeric, or composite material. Member 130 may be formed by pressing, molding, rolling, solvent casting the material into the desired shape and size. For instance, inorganic materials include water soluble inorganic compounds, in particular, salts, such as LiCl, LiBr, Li₂S, KCl, KBr, and others. The shock absorbing members in this case can be fabricated by pressing inorganic powders or granules. Important examples of organic materials are water soluble sugars, in particular, monosaccharides, disaccharides (lactose), polysaccharides (starch derivatives) as well as sugar alcohols (mannitol). Another important example of an organic compound as shock absorbing member 130 is synthetic urea, which has very high solubility in seawater and can be easily pressed into a solid layer from its granular form. In embodiments, shock absorbing member 130 is based on poly (ethylene oxide). Member 130 can be fabricated with the solution casting technique using organic solvents or water as solvents. PEO molecular weight can be in the range from 10³ g/mol. to 10⁶ g/mol.

A very important quality of PEO as a shock absorber is its elasticity. Mechanical properties of a PEO-based shock absorbing member 130 can be modified by blending PEO with other polymers, or changing its molecular weight, or using PEO-based composites (especially, for improving the mechanical strength of the spacer). Particular examples are PEO/PMMA, PEO/MC (methylcellulose), PEO/PVC and others. Examples of composites: PEO/PAN fibers, PEO/carbon fibers, PEO with inorganic fillers (silica, alumina, lithium solid electrolyte particles, etc.). In the case when member 130 contains not only water soluble, but also water insoluble components, it's important to make sure that after battery immersion in seawater that these components can be drift away from the interelectrode gap, in particular by making use of water flow.

In various embodiments a dual or multi-layer structure of a shock absorbing member 130 based on PEO can be used so that layers have different compositions and mechanical properties. In particular, in a three-layer architecture a middle PEO layer can be reinforced with fibers or inorganic fillers, while the two outer layers in direct contact with anode 311 and cathode 121 are not reinforced.

In another embodiment, the PEO-based shock absorbing member is loaded with chemicals (such as described in U.S. Pat. No. 9,905,860) that in contact with seawater generate heat to improve the battery start-up behavior. In another embodiment, the same goal may be achieved by using solid PEO-based electrolytes as spacer materials. Examples are PEO-LiTFSI, PEO-LiCF₃SO₃ (triflate), PEO-LiBr, and others.

Shock absorber member 130 can include two or more layers with different compositions. In particular, the layer in contact with the cathode can be loaded with inorganic salts or other compounds used for heat generation or improved conductivity, while the layer in direct contact with ceramic membrane can be free of these compounds. Alternatively, member 130 may include three layers. In various embodiments, only the middle layer is loaded with inorganic chemicals, in particular lithium salts, while the two layers in direct contact with electrodes are free of these chemicals.

In the embodiment illustrated in FIG. 3, spacer member 130a/b covers the portion of Li ion conductive ceramic membrane 309a/b that would otherwise be exposed to the ambient environment.

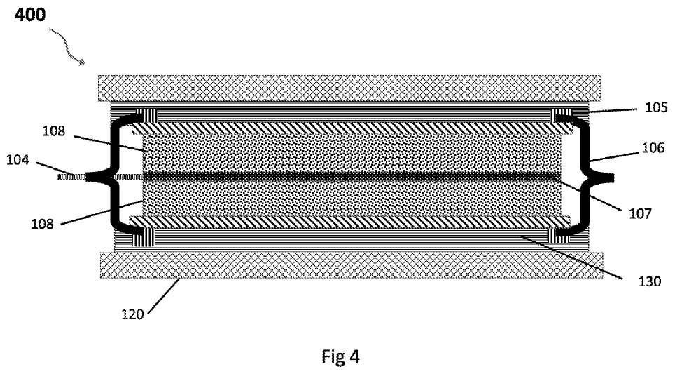

In various embodiments, shock absorbing member 130 is a material layer having a thickness that is capable of absorbing shock to protect the ceramic but thin enough to be volumetrically minimized. In yet other embodiments, shock absorbing member may be larger than the area of the exposed ceramic surface, as illustrated in FIG. 4. Battery 400 is similar to that described above with reference to FIG. 3, except in this embodiment shock absorbing member 430 is positioned onto the surface of the ceramic membrane and has thickness greater than that of the seal width, such that the positive electrode may be positioned on top of the spacer on the opposing side.

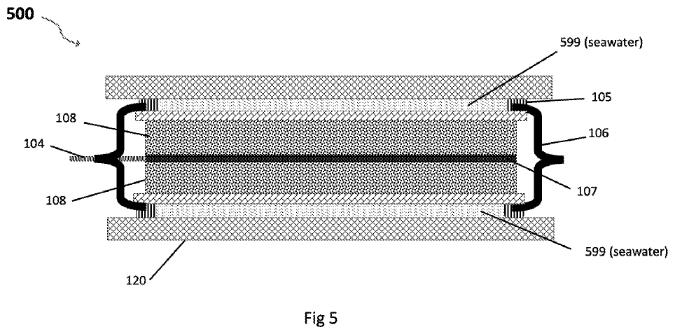

Once deployed and immersed into the waterbody for battery activation and operation, the shock absorbing member is caused to leave or dissolve or diffuse away from the inter-electrode gap between the anode and cathode electrodes. This is illustrated in FIG. 5, which shows activated and deployed battery 500 having an inter-electrode gap 599 on either side of the anode entirely filled with seawater, after the spacer member has dissolved or otherwise departed.

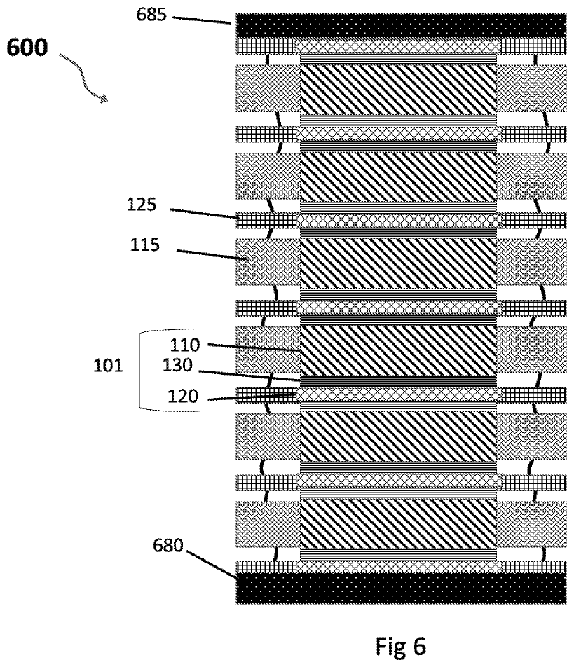

Ruggedized water activated battery assembly 600 is illustrated in cross section in FIG. 6. Stack 600 is composed of a plurality of adjacently stacked electrodes based on an alternate stacking of anode and cathode electrodes 110/120. The battery and their corresponding electrodes are center aligned. The stack orientation is non-limiting. In various embodiments the stack has a substantially vertical orientation (as shown in FIG. 6), and in other embodiments, for example, horizontal. Stack 600 includes distally positioned cover plates 685/680 respectively, and the distance between cover plates characterizes the stack height. It is generally desirable to minimize stack height during storage, shipping, and transport by stacking the electrodes and optional shock absorbing members in mechanical continuity (as shown in FIG. 6). In such a tight and compact stacking arrangement, mechanical strength is improved while also minimizing the overall volume of the electrode stack. In various embodiments stack assembly 600 is ruggedized and extensible, and includes suspension mechanism 650, which may be suspension cords attached between opposing electrodes via their peripheral framing members.

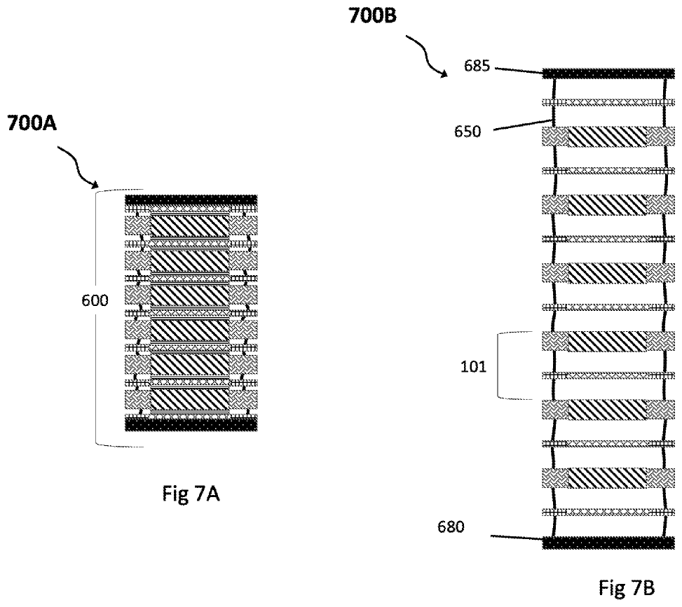

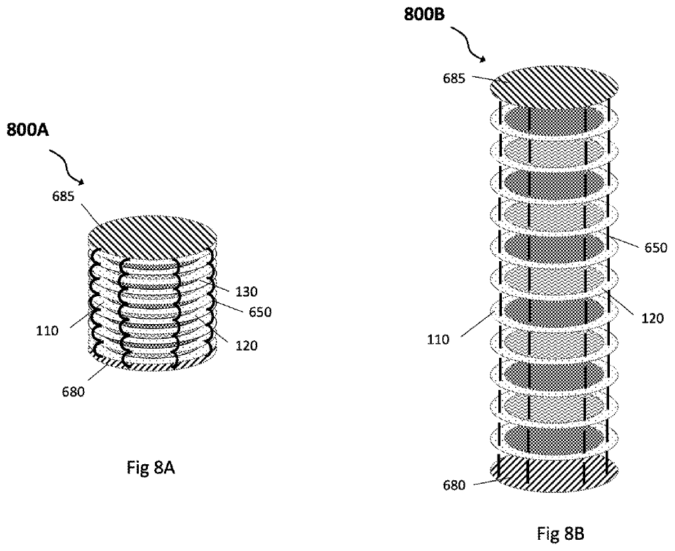

With reference to FIGS. 7A-B there is illustrated in perspective view ruggedized extensible water activated reserve battery assembly 700A/B composed of electrode stack 600 in its initial compact configuration (700A) and after deployment into a waterbody in an extended state (700B). Battery assembly 700A/B is composed of an alternate stacking of center aligned anode and cathode electrodes 110/120, extendable suspending mechanism 650 interfacing with each of the electrodes, and, in some embodiments, also having shock absorbing member 130 disposed between the electrodes to protect against the shock of a waterbody impact, for example if the battery is deployed by an aerial drop into the waterbody. In various embodiments suspending mechanism 750 is based on suspension cords attached (e.g., bonded) to the ring support framing members 115/125 of adjacently stacked electrodes. The battery is generally stored and/or transported to the deployment site in its compact configuration. Once deployed, cover plates 680/685 are caused to separate away from each other, which, in turn, increases the gap between the electrodes. The suspension cords interfacing with the framing members keep the electrodes center aligned and control the ultimate spacing of the inter-electrode gap during battery operation. In various embodiments the battery assembly is operated with a vertical orientation to take advantage of gravity and buoyancy for extending the electrodes and maintaining their spacing and alignment. In various embodiments, once stack 600 is deployed and immersed into a waterbody, cover plates 685/680 may be caused to extend away from each other, as shown in FIG. 7B. In various embodiments the extension is both gravity and buoyancy driven, with cover plate 680 drawn down toward the seafloor by gravity and a buoyancy force pulling upward on cover plate 685. In various embodiments the assembly extension is gravity driven by the weight of the battery and/or that of the underwater device being powered and/or by a weight of an anchor member on or above the seafloor. In the depicted embodiment, cover plate 680 applies a downward force onto stack 600 while a buoyancy element (e.g., a float), coupled to plate 685, applies an upward force. Battery assembly 700A/B is shown in perspective view in FIGS. 8A/B, respectively.

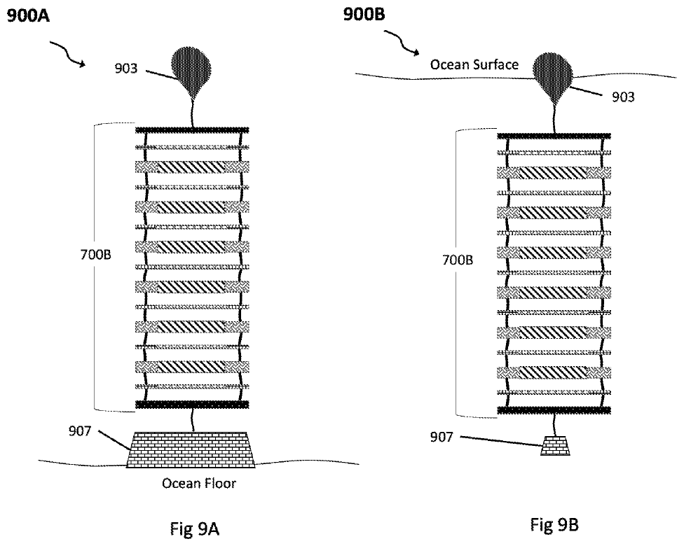

In FIGS. 9A-B the battery assembly is shown vertically oriented and extended by float 903 coupled to cover plate 680 and anchor member/weight 907a/b (e.g., a seafloor or drift anchor) coupled to cover plate 907. The battery assembly may be extended from the ocean floor (900A) or from the ocean surface (900B).

Although the present disclosure has been described in some detail with reference to a lithium water activated battery and electrode stack structure, the invention contemplates other types of active metal water-activated reserve type batteries, including those based on other anode electroactive metals (e.g., iron, magnesium, aluminum, and other alkali metals such as sodium).

1. A ruggedized lithium water-activated reserve battery for providing power to a marine device deployed in or on the surface of a waterbody, the battery comprising: a lithium anode having a major electrochemically active surface and a cathode having a major electrochemically active surface that adjacently opposes, but does not contact, the major electroactive surface of the anode, wherein the anode and cathode electrodes are positioned in a spaced apart relationship that defines an inter-electrode gap between the electrodes; the battery further comprising a shock absorbing member disposed within the inter-electrode gap in mechanical continuity with the anode and cathode electroactive surfaces, wherein the shock absorbing member is configured to enhance mechanical strength of the battery by absorbing axial forces resulting from the deployment impact between the device and the waterbody; and further wherein the battery has an open structure configured to receive liquid water from the waterbody environment once deployed therein, the liquid water of the waterbody used to support electrolyte functionality between the anode and cathode electrodes.

2. The ruggedized lithium water-activated reserve battery of claim 1 wherein the shock absorbing member is configured to drift away from the inter-electrode gap after the marine device has been deployed in/on the surface of the waterbody.

3. The ruggedized lithium water-activated reserve battery of claim 1 wherein the shock absorbing member is soluble in water and configured to dissolve into the waterbody after the marine device has been deployed in/on the surface of the waterbody.

4. The ruggedized lithium water-activated reserve battery of claim 2 wherein the shock absorbing member directly contacts the electroactive surface of the anode-electrode.

5. The ruggedized lithium water-activated reserve battery of claim 4 wherein the anode-electrode is a water-stable protected lithium electrode comprising a substantially impervious Li ion conducting ceramic membrane that defines the electroactive surface of the anode-electrode.

6. The ruggedized lithium water-activated reserve battery of claim 5 wherein the shock absorbing member comprises an inorganic salt that is soluble in contact with the waterbody.

7. The ruggedized lithium water-activated reserve battery of claim 5 wherein the inorganic salt is selected from the group consisting of LiCl, LiBr, Li₂S, KCl, and KBr.

8. The ruggedized lithium water-activated reserve battery of claim 5 wherein the shock absorbing member comprises an organic compound.

9. The ruggedized lithium water-activated reserve battery of claim 5 wherein the organic compound comprises a water-soluble sugar.

10. The ruggedized lithium water-activated reserve battery of claim 5 wherein the organic compound comprises synthetic urea.

11. The ruggedized lithium water-activated reserve battery of claim 5 wherein the organic compound comprises poly (ethylene oxide).

12. The ruggedized lithium water-activated reserve battery of claim 1 wherein the shock absorbing member is material blend comprising poly (ethylene oxide) and one more materials selected from the group consisting of PMMA, MC, and PVC.

13. The ruggedized lithium water-activated reserve battery of claim 1 wherein the anode electrode comprises a double-sided water stable protected lithium electrode comprising a lithium metal foil sandwiched between a pair of ceramic Li ion conducting membranes and a peripheral seal structure, wherein the seal structure extends beyond the surface of the ceramic membrane and therewith defines a basin region of certain depth.

14. The ruggedized lithium water-activated reserve battery of claim 11 wherein the shock absorbing member is configured to caulk the basin in direct touching contact with the ceramic membrane surface.

15. The ruggedized lithium water-activated reserve battery of claim 1 wherein the cathode comprises a MoS₂ catalyst.

16. The ruggedized lithium water-activated reserve battery of claim 1 wherein each electrode further comprises a peripheral framing member.

17. A battery assembly comprising an electrode stack structure comprising an alternating stacking of two more anodes and three or more cathodes as recited in claim 16.

18. The battery assembly of claim 17 further comprising a suspension mechanism that interfaces with the framing member of each electrode such that upon deployment of the battery assembly into the waterbody the suspension mechanism causes the inter-electrode gap to expand.
